(19) United States
(12) Patent Application Publication
(10) Pub. No.: US 2024/0331587 A1
(43) Pub. Date: Oct. 3, 2024

(54) FOLDABLE POP-UP BANNER

(71) Applicant: American Greetings Corporation, Cleveland, OH (US)

(72) Inventor: Charles Robert Kelly, Amherst, OH (US)

(21) Appl. No.: 18/432,259

(22) Filed: Feb. 5, 2024

Related U.S. Application Data
(60) Provisional application No. 63/455,175, filed on Mar. 28, 2023.

(51) Int. Cl. G09F 17/00

(52) U.S. Cl. CPC G09F 17/00; G09F 2017/0041

(57) ABSTRACT

A foldable garland or banner with pop-up elements that can be folded flat for easy storage, transport or delivery and can be unfolded into a unique, festive banner with pop-up elements. The pop-up elements are self-erecting when the banner is suspended from a loop attached to each distal end of the banner. The foldable banner is a low-cost, reusable, décor item that instantly creates a celebratory atmosphere.

### CROSS-REFERENCE TO RELATED APPLICATIONS

There are no applications related to this application.

### SUMMARY OF THE INVENTION

In one embodiment, the foldable banner of the present disclosure and related inventions includes a chain comprising a plurality of panels, each panel connected to at least one other panel at a 360-degree pivot point, a first panel attached to a first end of the chain and a last panel attached to a second end of the chain, the first and second panels having a hanging device attached thereto, a first pop-up element attached to the first panel, a second pop-up element attached to the last panel, wherein when the first and last panels are spaced apart and suspended from their respective hanging devices, the first and second pop-up elements move from a flat position to a raised position.

In another embodiment, the foldable banner includes a chain having a first link, a last link, and a plurality of intermediary links attached between the first link and the last link, at least two pop-up elements, a first pop-up element attached to the first link of the chain and a second pop-up element attached to the last link of the chain, a first sliding panel attached to the first link and the first pop-up element, a second sliding panel attached to the last link and the second pop-up element, the first and second sliding panels each having a loop attached thereto, wherein when chain is suspended by the loops contained on the first and second links, the pop-up element moves from a first or flat position, to a second, raised position.

And in still another embodiment, the foldable banner includes a chain comprised of a first link a last link and a plurality of intermediary links connected between the first and last links, the first link and the last link each comprising an inner panel and an outer panel, a first pop-up element attached to the first link and a second pop-up element attached to the last link, a first slider panel located between the inner and outer panels of the first link, a second slider panel located between the inner and outer panels of the last link, the first and second slider panels each having a hanger device attached thereto, wherein when the first and second slider panels are suspended by the hanger device, the first and second pop-up elements move from a first or flat position, to a second or raised position.

### BRIEF DESCRIPTION OF DRAWINGS

FIG. 1 is a perspective view of the foldable pop-up banner of the present invention.

FIG. 2 is a front view of the foldable pop-up banner of FIG. 1.

FIG. 3 is a top-down view of the foldable banner of FIG. 1.

FIG. 4 is a front-view of a portion (pop-up element) of the foldable banner of FIG. 1.

FIG. 5 is a top-down view of FIG. 4.

FIG. 6 is a view of FIG. 4 from the perspective of arrow 6-6.

FIG. 7 is a perspective view of FIG. 4, in a first position.

FIG. 8 is perspective view of FIG. 4, in a second position.

FIG. 9 is a front view of a first link of the foldable pop-up banner.

FIG. 10 is a front view of an attachment portion of the foldable pop-up banner.

FIG. 11 is a front view of a decorative portion of the foldable pop-up banner.

FIG. 12 is a front view of a slider panel of the foldable pop-up banner.

FIG. 13 is a perspective view of the slider panel of FIG. 12.

FIG. 14 is a front view of a last link of the foldable pop-up banner.

FIG. 15 is a front view of an intermediate link of the foldable pop-up banner.

FIG. 16 is a perspective view of a last link connection with an intermediate link of the pop-up banner.

### DETAILED DESCRIPTION OF THE INVENTION

The present disclosure and related inventions feature a foldable pop-up garland or banner (hereinafter “foldable banner”) with pop-up elements. The foldable banner can be folded flat for easy storage, transport or delivery and can be unfolded into a unique, festive banner with pop-up elements. The pop-up elements are self-erecting (at the opposing ends of the foldable banner) when the foldable banner is suspended from a loop attached to each distal end of the banner. The foldable banner is a low-cost, reusable, décor item that instantly creates a celebratory atmosphere.

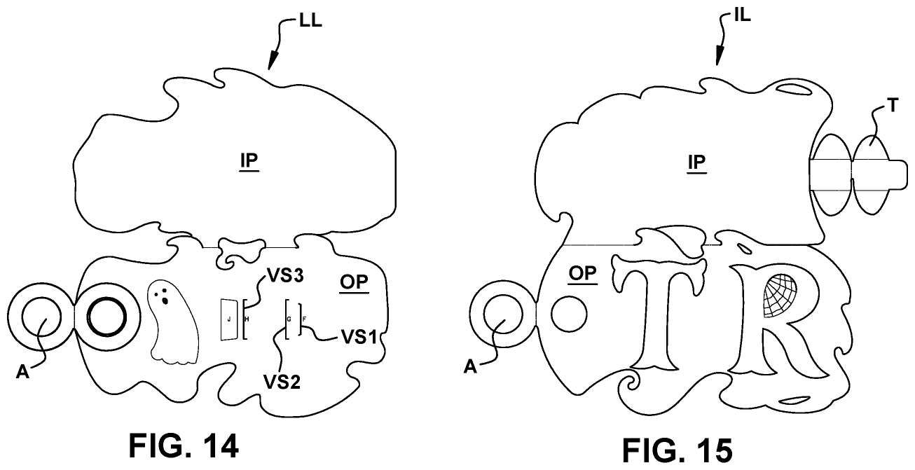

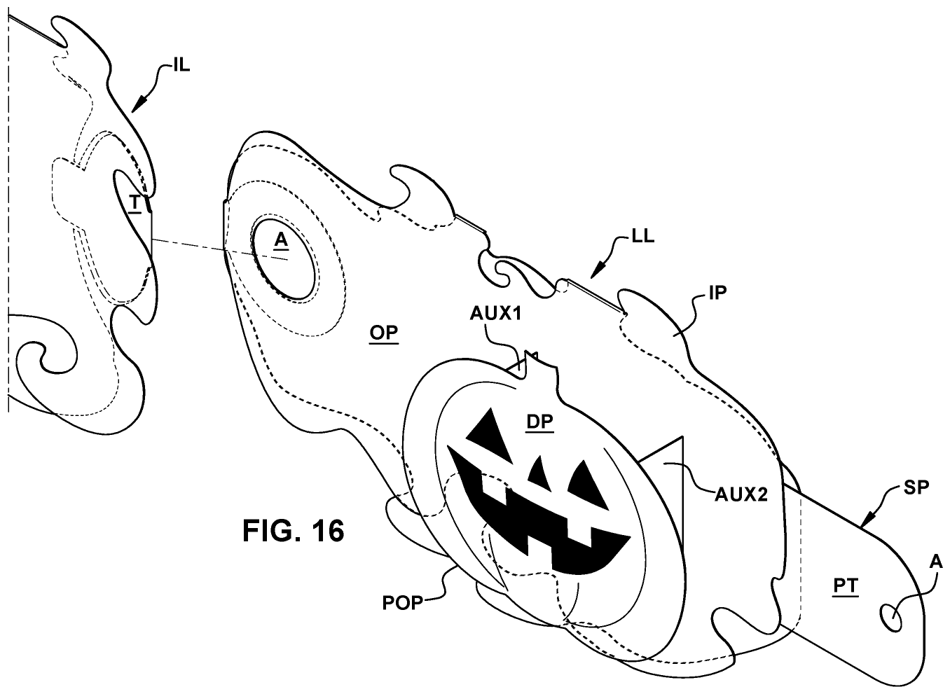

Individual links make up the foldable banner 100, with each link connected to another link in a way that allows them to pivot about the links that are connected thereto. The foldable banner 100 has a first end and a second end opposite the first end. A first link FL (see FIG. 9) is located at the first end of the foldable banner 100 and a last link LL (see FIG. 14) is located at the second end of the foldable banner 100, and a plurality of intermediate links IL (see FIG. 15) are attached between the first link FL and the last link LL of the foldable banner 100.

All links FL, IL, LL contain a first, or outer-facing panel OP and a second inner-facing panel IP. Each inner- and outer-facing panel IP, OP contain a first surface and a second surface opposite the first surface. The inner- and outer-facing panels IP, OP can have the same shape, or they can have different shapes. They can have smooth edges or decorative edges. The inner and outer-facing panels IP, OP, in a preferred embodiment, are of substantially the same size. The inner-facing panel IP and the outer-facing panel OP are attached to one another in a substantially overlapping manner, with the first surface of the inner-facing panel IP being attached to the second surface of the outer-facing panel OP. Each intermediate panel IL contains a circular aperture, hole, or opening A on a first end of the outer-facing panel OP and a tab T attached to a second end of the inner-facing panel IP. The tab T is substantially ovoid. The intermediate links IL are each attached or linked to one another by inserting the ovoid tab T on one link into the circular aperture, hole or opening A on another link, and so on. This creates a pivotable attachment point between two adjacent links.

Both the first link FL and the last link LL contain a sliding panel SP which is inserted between the inner facing panel IP and the outer facing panel OP thereof. The sliding panel SP, as shown in FIGS. 12 and 13, has a pull tab PT, a stopper tab ST, and a connection tab CT. The stopper tab ST and the connection tab CT are both connected, at a first end, to the pull tab PT. The outer-facing panel OP of the first and last links FL, LL contain three vertical slots thereon VS1, VS2, VS3. The second and third vertical slots VS2, VS3 are approximately the same size, with the first vertical slot VS1 being smaller than the second and third vertical slots VS2, VS3, as shown in FIGS. 9 and 14.

The pop-up elements POP include an attachment panel AP and a decorative panel DP, shown in FIGS. 10 and 11. Both the decorative panel DP and the attachment panel AP have an inner surface and an outer surface opposite the inner surface. The decorative panel DP can be of any shape, including holiday themed shapes such as, a Christmas tree, a pumpkin, a heart, a birthday cake, a flag, etc. Alternatively, the decorative panel DP can take on any non-holiday shape (ex. round, square, circular) and can have smooth or decorative edges (ex. scalloped, ornate). For example, the decorative panel shown in the drawings at FIG. 11 is shaped like a jack-o-lantern. The attachment panel AP includes a main sub-panel MSP, two auxiliary panels AUX1, AUX2, and two tabs T1, T2. The inner surface of the decorative panel DP is attached, via adhesive or other attachment mechanism, to the outer surface of main sub-panel MSP of the attachment panel AP. Both the decorative panel DP and the attachment panel AP may have printing or other decorative effects thereon.

To integrate the pop-up elements POP with the foldable banner 100, one pop-up element POP is attached to the first link FL of the foldable banner 100. The two auxiliary panels AUX1, AUX2 are folded such that they are parallel to each other and perpendicular to the main sub-panel MSP. The first tab T1 is inserted into the first vertical slot VS1 on the outer facing panel of the first link FL and attached to the inner surface thereof. The second tab T2 is attached to the outer surface of the of the outer facing panel OP of the first link FL, proximate the third vertical slot VS3. The slider panel SP is inserted between the inner and outer facing panels IP, OP of the first link FL along left hand side thereof. The connection tab CT is attached, at a second end thereof (opposite the first end which is attached to the pull tab PT portion of the slider panel SP), to the inner surface of the main panel MP of the pop-up POP and the second end of the stopper tab ST (opposite the first end which is attached to the pull tab PT) is inserted first into the third vertical slot VS3 and then into the and second VS2 vertical slot. This allows the slider panel SP to control the movement of the pop-up POP between a first position, wherein the pop-up POP is in a substantially flat, folded position, and a second position, wherein the pop-up POP is in an upright, unfolded, and raised position with respect to the foldable banner 100. The stopper tab ST also prevents the sliding panel SP to become completely removed from the foldable banner 100.

A pop-up element POP is also attached to the last link LL of the foldable banner 100, shown in FIGS. 4-8. As noted above, with respect to connection of a pop-up element POP to the first link FL, the two auxiliary panels AUX1, AUX2 are folded such that they are parallel to each other and perpendicular to the main sub-panel MSP. The second tab T2 is inserted into the first vertical slot VS1 on the outer facing panel of the last link FL and attached to the inner surface thereof. The first tab T1 is attached to the outer surface of the of the outer facing panel OP of the last link LL, proximate the third vertical slot VS3. The slider panel SP is inserted between the inner and outer facing panels IP, OP of the last link LL along right hand side thereof. The connection tab CT is attached, at a second end thereof (opposite the first end which is attached to the pull tab PT portion of the slider panel SP), to the inner surface of the main panel MP of the pop-up POP and the second end of the stopper tab ST (opposite the first end which is attached to the pull tab PT) is inserted first into the third vertical slot VS3 and then into the and second VS2 vertical slot. This allows the slider panel SP to control the movement of the pop-up POP between a first position, wherein the pop-up POP is in a substantially flat, folded position, and a second position, wherein the pop-up POP is in an upright, unfolded, and raised position with respect to the foldable banner 100. The stopper tab ST also prevents the sliding panel SP to become completely removed from the foldable banner 100.

To assemble the pieces of the foldable banner 100, the plurality of intermediate links IL must be attached to one another to create a chain. Each intermediate link IL contains a circular aperture, hole, or opening A on the first end thereof and a tab T on the second end thereof. Attachment points are created by inserting the tab T on one intermediate link IL into the circular aperture, hole, or opening A on another intermediate link IL, and so on, until all of the intermediate links IL are attached along the chain. The tab T on the first link FL is inserted into the circular aperture, hole, or opening A on left-most intermediate link IL (in the chain) and the tab T on the right-most intermediate link IL is inserted into the circular aperture, hole, or opening A on the last link LL, as shown in FIG. 16. All of the links (FL, LL, and IL) are pivotable 360-degrees about each attachment point.

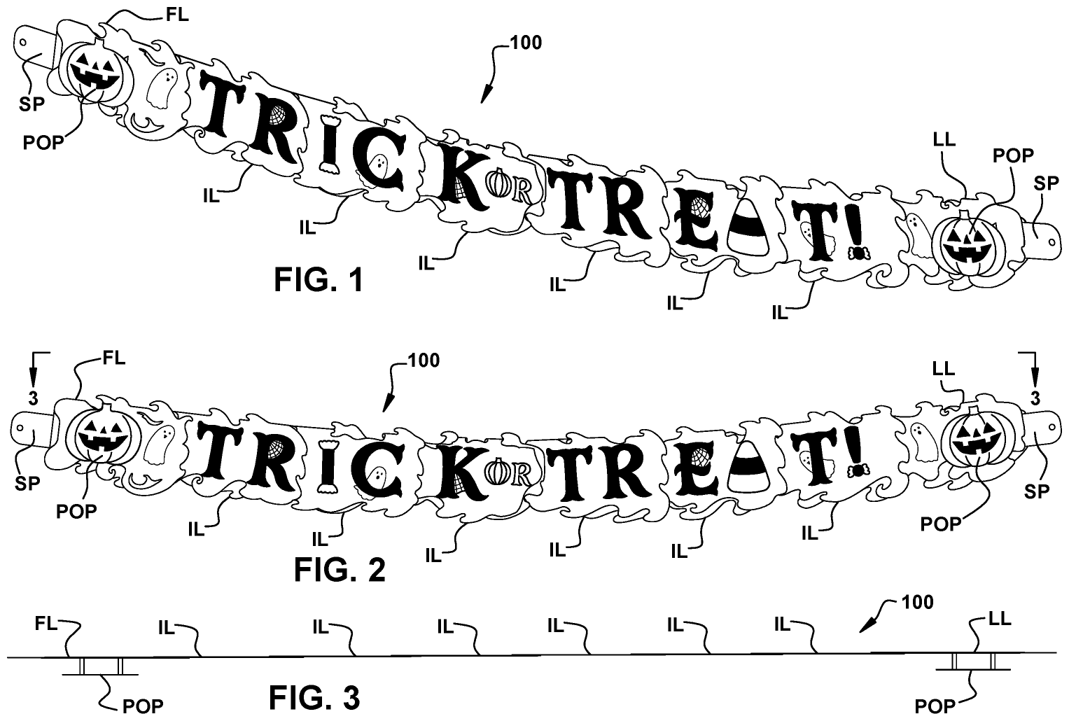

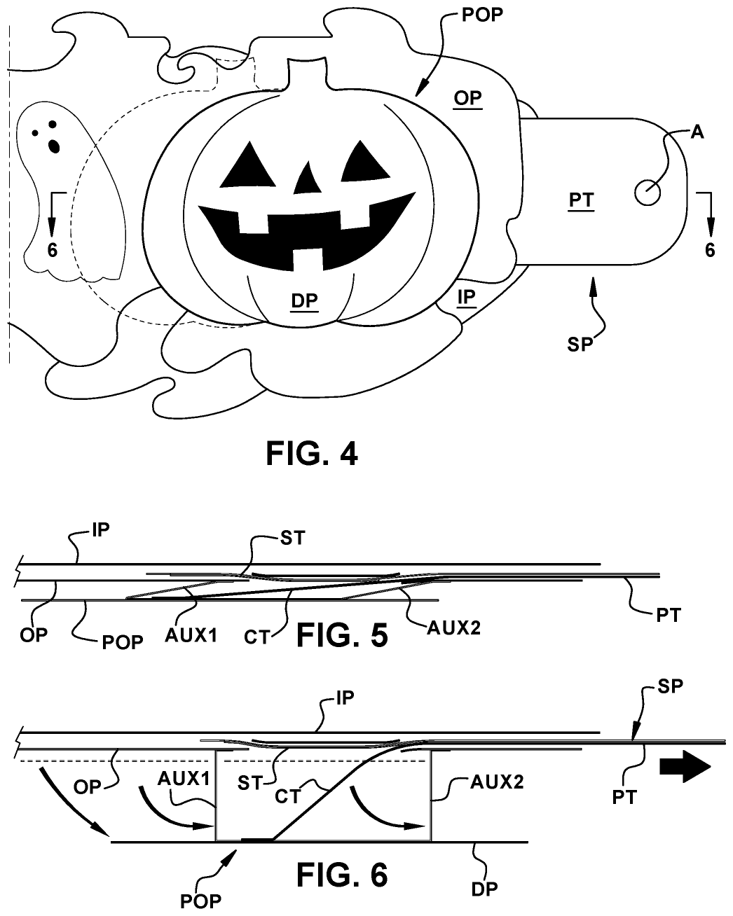

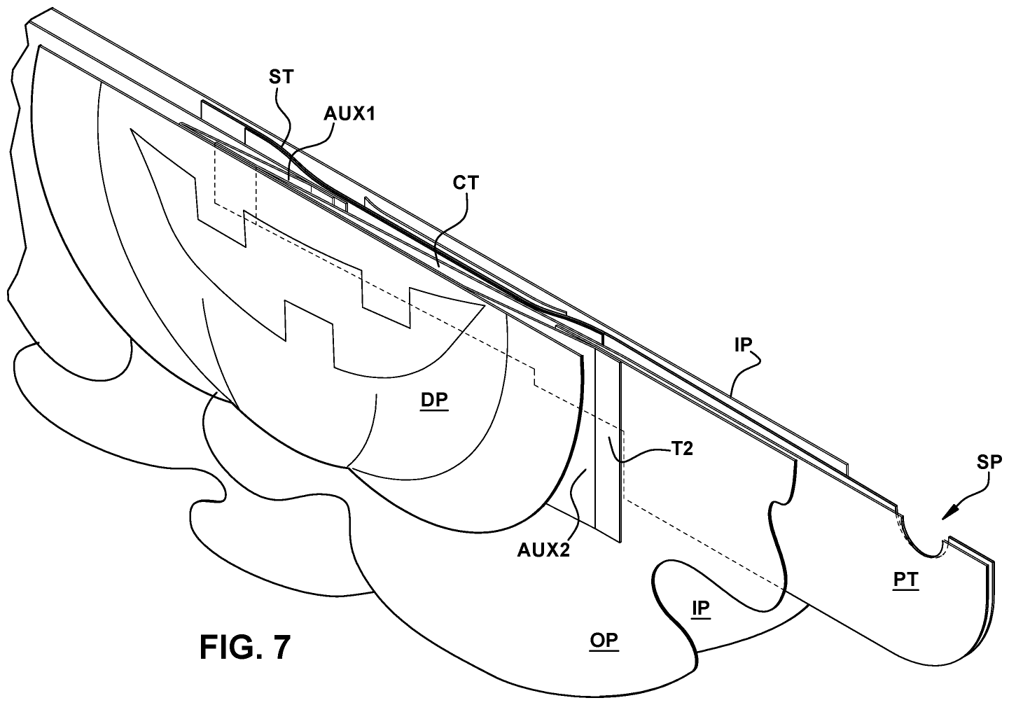

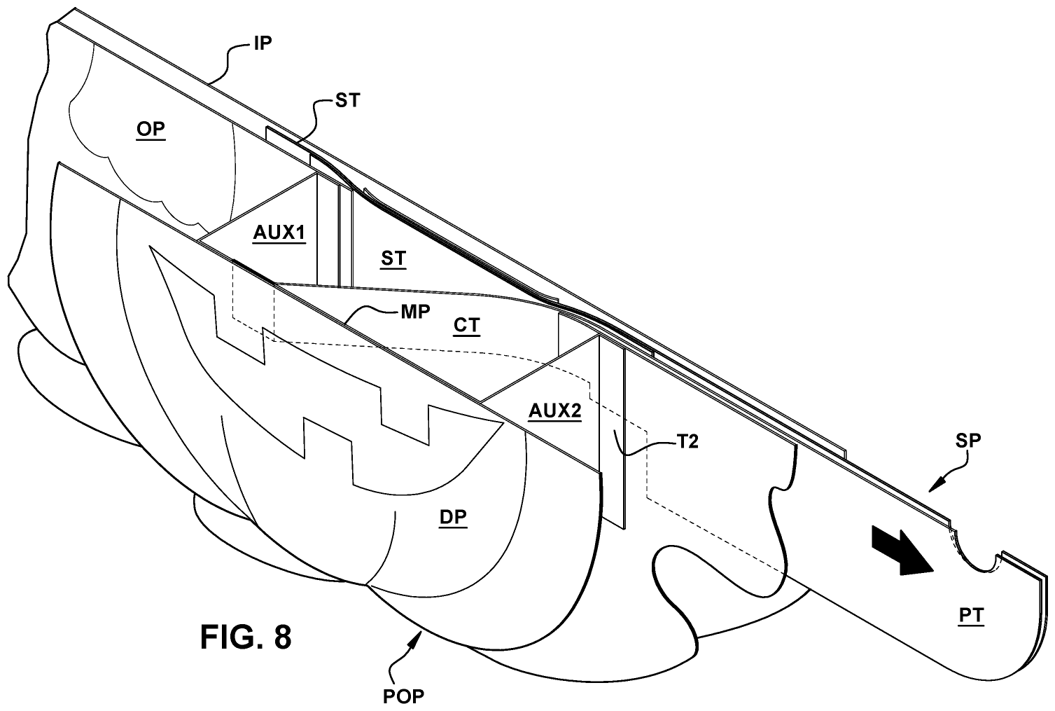

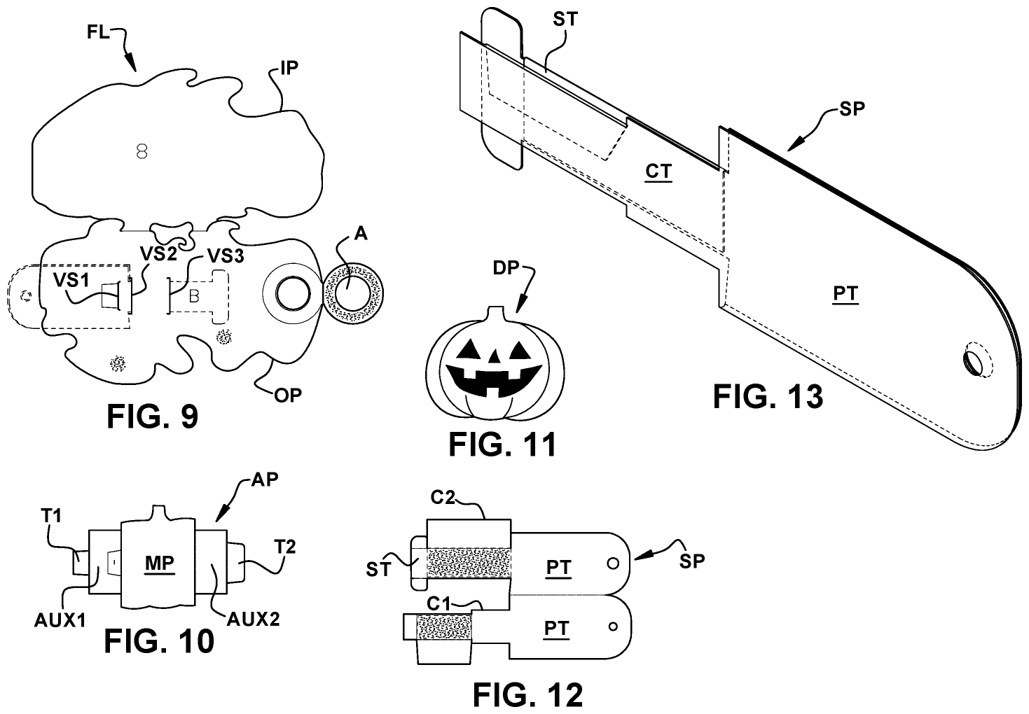

Beginning with the last link LL (at bottom), the second-to-last link can be pivoted to lie atop the last link LL, and so on, until the entire chain has been folded into a stacked arrangement with the first link FL at the top of the arrangement. The chain can move between this first, or stacked arrangement, and a second or unfurled position, shown in FIGS. 1-3.

As noted above, the first and last links FL, LL of the chain each contain an aperture, hole, or opening A contained thereon. A ribbon or other such item is inserted into each aperture, hole, or opening and tied to create a loop whereby the first link FL may be attached, hooked onto or looped over a first peg, nail, tack or other such protrusion and the last link LL may be attached, hooked onto, or looped over a second peg, nail, tack or other such protrusion a sufficient distance apart from the first peg, nail, tack, or other such protrusion. The first and second peg, nail, tack, or other such protrusions should be placed at a distance which is less than the width of the entire foldable banner 100 (including the ribbon loops) to allow sufficient draping of the foldable banner 100. When the ribbon loops are attached to the sufficient spaced apart peg, nail, tack, or other such protrusion the weight of the foldable banner hanging therebetween will cause the slider panels SP inserted between the inner and outer-facing panels IP, OP to withdraw from the first and last links FL, LL, causing the pop-up elements POP to move between the first or flat position and a second or raised position. Therefore, simply hanging the foldable banner 100 automatically causes the pop-up elements POP to move into the raised position, adding a three-dimensional element to the foldable banner 100.

In a preferred embodiment, the foldable banner 100 is made of paperboard, however, other materials have been contemplated and are considered to be within the scope of the present invention. The use of paperboard provides a low-cost option for consumers to decorate or make festive any area, at any time. Also, since the banner or garland can be folded into a stacked arrangement, it provides a lightweight, but sufficiently sturdy, decoration that can be sent to a recipient as a gift or stored away so that it can be re-used over and over again. The additional feature of the automatic movement of the pop-up elements (by hanging the banner), creates a unique decorative item that will delight a gift recipient or provide the user with an quick, easy, low-cost, durable, festive and fun decorative item that can be used for many years.

While the pop-up banner or garland of the present disclosure and related inventions has been described herein and shown in the figures with respect to a particular embodiment, nothing herein is intended to limit obvious variations. For example, while the banner has been described, with respect to a preferred embodiment, as being made from paperboard, other such lightweight, low-cost, durable materials can be used. The embodiment shown in the figures is directed to a Fall season or Halloween themed banner, other holidays, themes, motifs, shapes, sizes, colors and printing effects are considered to be in the scope of this invention. The number of links in the chain may be varied. The banner may additionally be adorned with glitter, charms, gems, googly eyes, and other such decorative embellishments.

The foregoing embodiments of the present invention have been presented for the purposes of illustration and description. These descriptions and embodiments are not intended to be exhaustive or to limit the invention to the precise form disclosed, and obviously many modifications and variations are possible in light of the above disclosure. The embodiments were chosen and described in order to best explain the principle of the invention and its practical applications to thereby enable others skilled in the art to best utilize the invention in its various embodiments and with various modifications as are suited to the particular use contemplated. It is intended that the invention be defined by the following claims.

1. A pop-up banner comprising:
a chain comprising a plurality of panels, each panel connected to at least one other panel at a 360-degree pivot point;
a first panel attached to a first end of the chain and a last panel attached to a second end of the chain, the first and second panels having a hanging device attached thereto;
a first pop-up element attached to the first panel;
a second pop-up element attached to the last panel;
wherein when the first and last panels are spaced apart and suspended from their respective hanging devices, the first and second pop-up elements move from a flat position to a raised position.

2. The pop-up banner of claim 1, wherein the plurality of panels in the chain are identical.

3. The pop-up banner of claim 1, wherein the plurality of panels in the chain are not identical.

4. The pop-up banner of claim 1, wherein the first and second pop-up elements are identical.

5. The pop-up banner of claim 1, wherein the first and second pop-up elements are not identical.

6. The pop-up banner of claim 1, wherein each of the plurality of links of the chain contain a circular opening at a first end thereof and a tab at a second end thereof.

7. The pop-up banner of claim 6, wherein the plurality of links of the chain are attached by inserting the tab of one of the plurality of panels into the circular opening of another of the plurality of links.

8. The pop-up banner of claim 1, wherein each of the plurality of links on the chain have an inner-facing panel and an outer-facing panel.

9. A pop-up banner comprising:
a chain having a first link, a last link, and a plurality of intermediary links attached between the first link and the last link;
at least two pop-up elements, a first pop-up element attached to the first link of the chain and a second pop-up element attached to the last link of the chain;
a first sliding panel attached to the first link and the first pop-up element;
a second sliding panel attached to the last link and the second pop-up element;
the first and second sliding panels each having a loop attached thereto;
wherein when chain is suspended by the loops contained on the first and second links, the pop-up element moves from a first or flat position, to a second, raised position.

10. The pop-up banner of claim 9, wherein there are at least six intermediary links.

11. The pop-up banner of claim 9, wherein there are more than six intermediary links.

12. The pop-up banner of claim 9, wherein the banner can move between a first or substantially flat position to a second, or unfurled position.

13. The pop-up banner of claim 9, wherein the first and second sliding panels cannot be removed from the first and last link, respectively.

14. The pop-up banner of claim 9, wherein each of the first, last, and plurality of intermediary links each have a circular opening at a first end and a tab at the second end.

15. The pop-up banner of claim 14, wherein each of the first, last, and plurality of intermediary links are attached to at least one other of the first, last, and plurality of intermediary links by inserting the tab of one link into the circular opening on another link.

16. A pop-up banner comprising:
a chain comprised of a first link a last link and a plurality of intermediary links connected between the first and last links;
the first link and the last link each comprising an inner panel and an outer panel;
a first pop-up element attached to the first link and a second pop-up element attached to the last link;
a first slider panel located between the inner and outer panels of the first link;
a second slider panel located between the inner and outer panels of the last link;
the first and second slider panels each having a hanger device attached thereto;
wherein when the first and second slider panels are suspended by the hanger device, the first and second pop-up elements move from a first or flat position, to a second or raised position.

17. The pop-up banner of claim 16, wherein the hanger device is a ribbon.

18. The pop-up banner of claim 16, wherein each of the first, last, and the plurality of intermediary links are pivotable 360-degrees about an adjacent link.

19. The pop-up banner of claim 16, wherein each of the first, last, and the plurality of intermediary links each contain an inner facing panel and an outer facing panel.

20. The pop-up banner of claim 16, wherein the chain contains at least 6 links.
